(19) United States
(12) Patent Application Publication
(10) Pub. No.: US 2026/0130314 A1
(43) Pub. Date: May 14, 2026

(54) METHOD FOR ESTIMATING THE GERMINATION PROPERTIES OF PLANT SEEDS AND TEST KITS

(71) Applicant: SEEDALIVE GMBH, Osnabrueck (DE)

(72) Inventor: Jens VARNSKUEHLER, Osnabrueck (DE)

(21) Appl. No.: 19/118,127

(22) PCT Filed: Sep. 26, 2023
(86) PCT No.: PCT/EP2023/076505

§ 371 Date: Apr. 3, 2025

(30) Foreign Application Priority Data
Oct. 5, 2022 (DE) 10 2022 125 712.6

(51) Int. Cl. A01C 1/02; G01N 21/31; G01N 21/84

(52) U.S. Cl. CPC A01C 1/025; G01N 21/31; G01N 2021/8466

(57) ABSTRACT

The invention relates to a method for estimating the germination properties of plant seeds, comprising the following method steps: a) providing a plurality of separate plant seed portions, each comprising at least one plant seed, b) producing or providing a test composition comprising: i) water, ii) a two-stage redox indicator, and iii) a fermenting microorganism, c) bringing the plant seed portions into contact with a respective test volume of test composition in order to obtain a plurality of separate test systems, and incubating the test systems, d) measuring the test compositions of the incubated test systems using an optical measuring method in order to determine the optical absorption properties of the respective test compositions for electromagnetic radiation at at least a first wavelength λ₁ and a second wavelength λ₂ for the purpose of obtaining a plurality of absorption data records assigned to the respective test systems, wherein the absorption data records comprise information about the absorption properties of the respective test compositions at the first wavelength λ₁ and the second wavelength λ₂, with λ₁ and λ₂ differing by 10 nm or more, e) evaluating the absorption data records assigned to the test systems for the purpose of estimating the germination properties of the plant seeds in the respective plant seed portions using a machine learning-based estimation module.

The invention relates to a method for estimating the germination properties of plant seeds, a test composition for use in such a method, a kit for producing a corresponding test composition and a computer program product for carrying out the steps of the corresponding method. An electronic data processing device for use in such a method is also disclosed.

One of the most urgent challenges facing humanity is how to reliably provide sufficient food to the growing world population. Against this backdrop, past and future innovations in the fields of agricultural engineering and agriculture take on particular significance. For many of the most important agricultural products, access to high-performance seeds that give rise to usable plants reliably and in a high yield is vital in order to obtain a maximum yield on available land surfaces.

Against this backdrop, in the field of agriculture, seeds constitute an important commodity subject to stringent requirements. In particular, these concern the capacity of the seeds to show sufficient germination capacity and seed viability after seeding. Evaluation of seed quality and ensuring that this quality remains uniform play such a prominent role in this context that international associations such as the Association of Official Seed Analysts (AOSA) and the International Seed Testing Association (ISTA), which are dedicated to ensuring seed quality and the testing and certification thereof, have been in existence since as early as 1908 and 1924.

The tests defined by the ISTA for determining the germination properties of seeds and the defined quality criteria constituted the undisputed industry standard in most countries of the European Union and are continuously updated by the ISTA. Accordingly, in the context of the present invention, it is above all the ISTA methods and criteria that are taken as a basis, wherein in many cases, these already differ only slightly from the AOSA criteria.

The classical methods for determining germination properties are based in a condensed summary on taking a representative seed fraction from a seed batch to be evaluated, wherein the test seeds obtained are subjected to conditions under which the seeds can germinate, wherein the presence of germination and the extent of seed viability for the individual seeds of the test group are determined and the characteristic germination properties for the seed batch are derived by stochastic evaluation.

Even though it has been undisputed to date that the tests specified by the ISTA are of the greatest relevance for the industry, the determination of germination properties by means of actual germination of the seeds is felt in many cases to be disadvantageous in view of the time needed for this and the amount of work required. Against this backdrop, there is continuing interest in providing methods with which the germination properties of plant seeds can be reliably and quickly estimated while seeking to obtain a satisfactory correlation with the germination properties stipulated by the ISTA.

A germination capacity test for plant seeds known from the prior art has been disclosed for example in DE 102020200567 A1. This germination capacity test is based on a method in which a number of plant seeds are brought into contact in separate containers with a predetermined volume of a test solution that comprises resazurin, i.e. a two-stage redox indicator, and yeast, i.e. a fermenting microorganism. The plant seeds are brought into contact with the test solution and incubated. In general, it is assumed that the germination capacity of plant seeds decreases with increasing damage to the seed hulls. During incubation, this damage to the seed hulls causes the escape of glucose and other organic substances from the inside of the seeds into the surrounding test solution. These substances can be at least partially reacted by the yeast, which leads to conversion of the two-stage redox indicator resazurin to resorufin or dihydroresorufin. This conversion results in a color change. DE 102020200567 A1 takes advantage of this in that the absorption of the test solution is measured at 570 nm in order to correlate the normalized absorption values with the actual germination properties obtained in the subsequently-described germination tests. By means of linear regression, functions can be estimated which allow germination properties to be estimated from absorption values for similar plant seeds. The method of DE 102020200567 A1, according to the inventors' assessment, essentially provides a highly promising germination capacity test, which in particular can be carried out significantly faster than methods based on actual seeding. This method, which allows the germination properties of a wide range of seeds to be at least roughly estimated, also provides advantages with respect to time and cost efficiency, is non-destructive, and in most cases causes only minor environmental impact.

Despite the above-described advantages of the method known from the prior art, this method is felt by many experts-including the inventors of the present invention—to be in need of improvement in many respects. In particular, the prediction quality that can be achieved with the method of prior art is regularly considered to be insufficient, in particular because in order to obtain robust correlations between absorption at 570 nm and germination capacity, extremely large data sets are usually required, and despite sometimes complex normalization processes, major dispersion is observed around the regressions obtained. The inventors assume that this deficiency in central functionality, i.e. the estimation of the germination properties, accounts for the fact that this method for analyzing the germination capacity of plant seeds, which is advantageous per se, has not yet become comprehensively established in the industry despite the above-described advantages.

The primary object of the present invention is to eliminate or at least alleviate the above-described drawbacks of the prior art.

In particular, the object of the present invention is to disclose a method for estimating the germination properties of plant seeds by means of which the germination properties of plant seeds can be estimated particularly reliably and precisely.

In this context, an object of the present invention is to allow the method to be provided to be carried out as a non-invasive method that does not destroy the tested plant seeds and is preferably as unproblematic as possible with respect to environmental and health-related aspects.

In addition, an object of the present invention is to allow the method to be provided for estimating germination properties and evaluation to be significantly faster than the germination capacity test known from the prior art, so that the method to be provided shows higher time and cost efficiency.

An additional object of the present invention is to allow the method to be provided to be efficiently implemented in an at least partially decentralized configuration, so that estimation of the germination properties of plant seeds can also be carried out outside of research institutions and with the minimum possible equipment requirements.

A further object of the present invention is to allow the method to be provided to be applicable to a wide range of possible plant seeds, and regardless of the plant seeds used, to allow reliable estimation of germination properties.

In this context, it is an object of the present invention to allow the method to be provided to be capable of reliably estimating the particular germination properties of germination capacity and seed viability.

A further object of the present invention is to allow the method to be provided to be easily automatable and suitable for high throughput rates. In addition, the method to be provided is preferably to be configured in such a way that it allows particularly simple handling and has relatively few requirements with respect to education and training of the personnel used in the method.

A further object of the present invention is to provide a particularly advantageous test solution for use in the method to be provided and a kit for producing plant-seed-specific test compositions.

In addition, a further object of the present invention is to provide a computer program product by means of which essential method steps of the method to be provided can be carried out on an electronic data processing device.

A secondary object of the present invention is to provide an electronic data processing device suitable for use in the method to be provided.

The inventors of the present invention have now found that surprisingly, the above-described objects can indeed be achieved if, starting from a germination capacity test known from the prior art based on the use of resazurin and yeast and photometric evaluation of the color changes in resazurin at 570 nm, absorption properties are instead detected at two sufficiently differing wavelengths and the absorption data sets obtained in this manner are evaluated using machine learning techniques, as defined in the claims.

Surprisingly, by means of this modification of the method known from the prior art, i.e. the detection of at least two wavelengths sufficiently separated from each other and the use of machine learning methods, one obtains advantageous methods that can assess the germination properties of plant seeds with a significantly improved prognostic accuracy, wherein the resulting method is fast, inexpensive, safe, and seed-sparing, and in particular can be used in decentralized configurations with relatively low equipment requirements and low requirements for the amount of training of the personnel used. A significant and consistent improvement in prediction of the most important germination properties is achieved compared to the germination test knows from the prior art.

The above-mentioned objects are thus achieved by the subject matter of the invention as described in the claims. Preferred embodiments according to the invention are described in the dependent claims and the following explanations.

Embodiments designated in the following as preferred are combined in particularly preferred embodiments with features of other embodiments designated as preferred. Combinations of two or more of the embodiments designated in the following as particularly preferred are thus most particularly preferred. Also preferred are embodiments in which a feature of an embodiment that is described to any extent as preferred is combined with one or more further features of another embodiment that are described to any extent as preferred. Features of preferred test compositions, kits, electronic data processing devices and computer program products can be derived from the features of preferred methods.

In the following, for an element, for example for the two-stage redox indicator or the fermenting microorganism, if both specific amounts or proportions of this element and preferred embodiments of the element are disclosed, in particular, the specific amounts or proportions of the preferably configured elements are also disclosed. In addition, it is disclosed that in the corresponding specific total amounts or total proportions of the elements, at least a portion of the elements can be preferably configured and in particular also that preferably configured elements may also be present in the specific amounts or proportions within the specific total amounts or total proportions.

The invention relates to a method for estimating the germination properties of plant seeds, comprising the following method steps:
a) providing a plurality of separate plant seed portions, each comprising at least one plant seed,
b) producing or providing a test composition comprising:
i) water,
ii) a two-stage redox indicator, and
iii) a fermenting microorganism,
c) bringing the plant seed portions into contact with a respective test volume of test composition in order to obtain a plurality of separate test systems, and incubating the test systems,
d) measuring the test compositions of the incubated test systems using an optical measurement method in order to determine the optical absorption properties of the respective test compositions for electromagnetic radiation at at least a first wavelength λ₁ and a second wavelength λ₂ in order to obtain a plurality of absorption data records assigned to the respective test systems,
wherein the absorption data sets comprise data on the absorption properties of the respective test compositions at the first wavelength λ₁ and the second wavelength λ₂,
wherein λ₁ and λ₂ differ by 10 nm or more,
e) evaluating the absorption data sets assigned to the test systems for the purpose of estimating the germination properties of the plant seeds in the respective plant seed portions using an electronic data processing device, wherein the electronic data processing device comprises a storage unit, wherein a machine-learning-based estimation module is stored on the storage unit,
wherein the electronic data processing device is configured to enter the absorption data sets obtained for the plant seed portions into the estimation module as input and to estimate the germination properties of the plant seeds in the plant seed portions using the estimation module,
wherein the estimation module is trained to estimate the germination properties of the plant seeds in the plant seed portions from the absorption data sets, wherein the training is carried out by means of supervised learning with a set of training data comprising a plurality of training absorption data sets of training plant seed portions of plant seeds with known germination properties.

The method according to the invention is used for estimating the germination properties of plant seeds. In terms of language, this contrasts with the formulation used in DE 102020200567 A1 of a “germination capacity test,” but it appears to the inventors to me more appropriate. The reason is that strictly speaking, the germination properties of the plant seeds in the method according to the invention are not tested or analyzed, such would be the case for ISTA tests. Rather, the method according to the invention is based on predicting germination properties in plants of seeds that have not been subjected to germination through correlation with absorption values measured in subsequently germinated, similar plant seeds, so that the actual test of germination properties can be avoided. The term “germination properties,” according to the understanding of a person skilled in the art, express than analogously to the various evaluation criteria developed from the ISTA, in addition to germination capacity, further parameters are to be assigned to the germination, i.e. for example seed viability, wherein these properties can also be advantageously determined by the method according to the invention. A method according to the invention is therefore exemplary wherein the estimated germination properties indicate in each case an estimation of the probability that the plant seeds of the plant seed portion will physiologically germinate, and preferably the probability that the plant seeds of the plant seed portion physiologically germinate within a predetermined observation period after seeding, wherein the presence of physiological germination is particularly preferably checked every 24 h. In accordance with the understanding of the person skilled in the art, “physiological germination” can be understood as the breaking through of a root from a plant seed having a length of at least 2 mm, wherein this is sometimes referred to as a “white root tip.” In practice, however, the precise criteria are based in each case on the current ISTA criteria. Additionally or alternatively, a method according to the invention is also exemplary wherein the estimated germination properties in each case comprise estimation of the probability that the plant seeds of the plant seed portion will form a normal seedling as defined by the ISTA criteria. A normal seedling as defined by the current ISTA criteria is present if a seed form a healthy, complete seedling that can be expected to develop into a complete plant.

The person skilled in the art understands that the method according to the invention can be efficiently used in order to determine the germination properties of a plurality of plant seeds. In practice, analogously to the method developed by the ISTA, the most relevant application is one in which the germination properties of a large seed batch are determined via analysis of a representative partial amount of plant seeds.

In the method according to the invention, in method step a), a plurality of plant seeds is first provided, and this may for example be a corresponding representative partial amount of a larger seed batch, wherein these plant seeds are divided into separate plant seed portions. In order to avoid any effect of contamination on the surface of the plant seeds, it is usually advisable to at least roughly clean the plant seeds prior to the method, for example by washing them off with distilled water.

As also specified below, according to the inventors' assessment, the method according to the invention is used in most cases in order to identify an overall evaluation parameter for the entirety of the plant seeds, i.e. a bulk parameter (bulk property) or a prediction of mean germination properties for the seed batch. Against this backdrop, it es generally possible to use two or more plant seeds together as plant seed portions, so that for example 100 plant seed portions with two plant seeds for each plant seed portion can be used. In the inventors' assessment, however, it is preferred in view of the attainable resolution of the germination properties, to use separate plant seeds in each case as the plant seed portion, as this prevents differences in the germination properties of the plant seeds from disappearing due to averaging, which for example would be the case if a plant seed with a particularly advantageous germination capacity were measured together with a plant seed having lower germination capacity in a common plant seed portion. For essentially all embodiments, according to the understanding of the person skilled in the art, a method according to the invention is preferred wherein the plant seed portions comprise the same number of plant seeds in order to allow efficient experimental planning. For essentially all embodiments, a method according to the invention is particularly preferred wherein the plant seed portions are consisting of one or two, and preferably one plant seed, and/or wherein each test system comprises exactly one plant seed.

In method step b), a test composition is produced or provided, wherein the latter can take place for example by purchasing a finished test composition from a supplier. In the inventors' assessment, however, in the majority of cases, the test composition is subject to certain aging phenomena, so that in view of the achievable estimation quality, it is particularly preferred to produce the test composition in the method according to the invention.

For example, this can be carried out by not mixing the two-stage redox indicator and the fermenting microorganism with water until immediately prior to carrying out the further method steps in order to produce the test solution. This type of process management is highly advantageous in that an undesired color change in a portion of the redox indicator, which can occur in the formulated test composition as signs of aging, can be prevented. Accordingly, a method according to the invention is preferred wherein the test composition is produced in method step b), wherein the test composition is preferably provided 2 h or less, particularly preferably 1 h or less, most particularly preferably 0.5 h or less, and in particular immediately before combined seed portions.

The method according to the invention is advantageously suitable for application in a wide range of plant seeds. In fact, based on the available test data, the inventors have no reason to assume that the method according to the invention would not be suitable for certain species of plant seeds. By means of extensive tests, the inventors have established the applicability of the method for a wide range of plant seeds of the most widely differing types. In this respect, therefore, a method according to the invention is preferred wherein the plant seeds are seeds of plants that are selected from the group consisting of plant seeds of gymnosperms (Gymnospermae) and angiosperms (Angiospermae), preferably selected from the group consisting of plant seeds of gymnosperms (Gymnospermae), monocot gymnosperms (Monocotyledonae) and dicot gymnosperms (Dicotyledonae), particularly preferably selected from the group consisting of the plant seeds of:
Sweet grasses (Poaceae), for example Alopecurus, Avena, Hordeum, Lolium, Poa, Secale, Triticum, Triticale, Zea;
Amaryllis plants (Amaryllidaceae), for example Allium;
Asparagus plants (Asparagaceae), for example Asparagus;
Apiaceae, for example Apium, Daucus, Petroselinum;
Asteraceae, for example Helianthus;
Brassicaceae, for example Brassica, Lepidium, Raphanus, Sinapis;
Caprifoliaceae, for example Valerianella;
Chenopodiaceae, for example Beta;
Cucurbitaceae, for example Cucumis;
Fabaceae, for example glycine, Lens, Pisum, Trifolium, Vicia, Lupinus;
Lamiaceae, for example Ajuga, Lavendula;
Ranunculaceae, for example Delphinium;
Rosaceae, for example Fragaria, Filipendula;
Solanaceae, for example Lycopersicum, Solanum.

In a most particularly preferred method according to the invention, the plant seeds are seeds of the plants shown in Tables 1 and 2.

In the method according to the invention, the various components of the test composition are of varying significance. According to the invention, the solvent must comprise water, as the presence of water is essential for the subsequently desired functionality. At least generally, it is possible that other solvents are present in addition to water, with the test composition thus constituting as a whole an aqueous solvent. In practice, however the inventors find it advantageous with a view factors such as environmental compatibility, the seed-containing nature of the method, and the total costs, if the solvent used in the test composition consists to 95% or more, preferably 98% or more, particularly preferably 99% or more, and most particularly preferably essentially completely, of water based on the mass of the solvent, which advantageously also makes it possible to prevent any further solvent components from negatively impacting the activity of the fermenting microorganism and/or the color change behavior of the redox indicator. Accordingly, a method according to the invention is preferred wherein the water is distilled or demineralized water.

In the prior art, test compositions are sometimes referred to as test solutions. According to the understanding of the person skilled in the art, however, the test composition is not in all cases a solution in the narrower sense, i.e. an essentially homogeneous solution. The person skilled in the art understands that the term test composition is more suitable because in addition to test solutions, it also comprises such liquid systems in which undissolved particles are optionally present, for example as a result of an incompletely-dissolved fermented microorganism, so that these systems should rather be referred to as test suspensions.

The text composition to be used comprises a two-stage redox indicator by means of which a change in the redox potential of the test composition can be indicated. From the prior art, redox indicators per se and their functioning are as well-known to the person skilled in the art as two-stage redox indicators. These two-stage redox indicators show two transitions, in which due to a reduction or oxidation reaction, the absorption properties change, and thus in most cases the visually perceptible color as well. Two-stage redox indicators thus show three different redox states between which the two redox transitions are located.

In the inventors' assessment, the concept on which the method according to the invention is based can generally be implemented using any two-stage redox indicator. Because of the application already known from the prior art, the advantageous risk profile, and the absorption wavelength ranges of the various redox states that are favorable for apparatus evaluation, however, resazurin in particular is predestined for use in the method according to the invention and is preferred for all embodiment as a two-stage redox indicator. Resazurin is therefore thoroughly familiar to the person skilled in the art from the prior art, and like other redox indicators, is commercially available from various manufacturers. A method according to the invention is preferred wherein the two-stage redox indicator is selected from the group consisting of dyes with a phenoxazin-3-one basic scaffold, for example resazurin, wherein the preferred two-stage redox indicator is resazurin.

As a further component, the test composition comprises a fermenting microorganism. The term “fermenting microorganism” is clear for the person skilled in the art and designates microorganisms such as e.g. bacteria and fungi that are capable of microbially or enzymatically converting organic substances, in particular glucose, by means of so-called fermentation. In the inventors' assessment, unicellular fungi, which are known to person skilled in the art for example in the form of yeasts such as e.g. brewer's yeast, are particularly suitable as fermenting microorganisms. Accordingly, a method according to the invention is preferred wherein the fermenting microorganism is selected from the group consisting of unicellular fungi, preferably selected from the group consisting of yeasts, particularly preferably selected from the group consisting of Saccharomyces cerevisiae and Saccharomyces bayanus. With respect to the production of the solution, a method according to the invention is preferred wherein the test composition is produced in method step b), wherein the fermenting microorganism is used as a cold-treated microorganism, preferably as a freeze-dried microorganism.

In the method according to the invention, the test composition, at least in its most broadly-defined form, has the same object that is also known from the prior art, while the preferred test compositions disclosed below also fulfil additional functions. Without wishing to be restricted to this theory, the inventors assume that processes taking place in the method according to the invention can be described as follows. In a dry state, selectively permeable membranes are not functional in the plant seeds. After contact with water, the plant seeds begin to absorb water. Depending on physiological constitution, complete or deficient reconstitution of the selectively permeable membrane occurs, so that leaching of storage substances such as carbohydrates, proteins, or fats occurs to differing degrees. In the event of favorable constitution, the seed controls leaching so that only a small concentration of these organic substances is present in the test composition. In contrast to this, reconstitution of the selectively-permeable membrane is virtually absent in dead plant seeds. This results in strong leaching of storage substances, which accordingly are found in increased concentrations in the test composition. Accordingly, the state of the plant seeds correlates with the amount of organic substances available to the fermenting microorganism in the test composition during incubation. Depending on the vitality of the plant seeds, the activity of the microorganisms in the test composition therefore varies. The redox indicator is now used to make the varying activity of the microfermenting microorganisms detectable or even visible. This can be illustrated using resazurin as an example. Resazurin is a two-stage redox indicator that when fully oxidized has a dark blue-violet color. Following a first reduction, the color changes in the direction of pink (irreversible), while following a second reduction, a colorless form is obtained (reversible). In other words, this is a method according to the invention, wherein in the course of fermentation of fermentable compounds, the fermenting microorganism can change the redox potential of the test composition, and/or wherein the test composition is configured such that the fermentation of fermentable compounds by the fermenting microorganism in the test composition first triggers a first color change and then a second color change in the two-stage redox indicator, or a first reduction and then a second reduction.

The inventors realized that it is advisable in order to achieve particularly advantageous estimation results to adapt the composition of the test composition to the plant seeds to be tested in the method according to the invention, in particular with respect to the concentration of the redox indicator and the fermenting microorganism. In this respect, the inventors recommend that in a kit according to the invention, as disclosed below, in particular plant-seed-specific production instructions can be provided for the production of a corresponding test composition from a prepared solid, for example a powder, by mixing with water or an aqueous solvent, in order to allow specific mixing of the components. In this respect, the inventors succeeded in identifying generally preferred ranges by means of which, according to the inventors' assessment, particularly advantageous test compositions can be obtained that can be used for a wide range of plant seeds even without plant-seed-specific production. Specifically, a method according to the invention is preferred wherein the mass fraction of water in the test composition is 70% or more, preferably 80% or more, particularly preferably 90% or more, more particularly preferably 95% or more, and most particularly preferably 99% or more based on the mass of the test composition. Additionally or alternatively, a method according to the invention is preferred wherein the mass fraction of the two-stage redox indicator in the test composition is in the range of 0.00001 to 5%, preferably in the range of 0.001 to 0.5%, particularly preferably in the range of 0.01 to 0.05%, based on the mass of the test composition. Moreover, additionally or alternatively, a method according to the invention is preferred wherein the mass fraction of the fermenting microorganism in the test composition is in the range of 0.01 to 10%, preferably in the range of 0.05 to 5%, particularly preferably in the range of 0.1 to 0.5%, based on the mass of the test composition.

In method step c), the plant seed portions are brought into contact with a test volume of test composition. According to the understanding of the person skilled in the art, this means that each plant seed is brought into contact with a separate portion of the test composition. This bringing into contact can advantageously be carried out in a suitable container, wherein the use of so-called multiwell plates in particular is advisable because of the usually large number of plant seeds that are usually investigated simultaneously in the method according to the invention. Accordingly, in many cases, a method according to the invention is effective wherein the plant seed portions are brought into contact with one test volume each of test composition in one test recess each from a plurality of test recesses of a first test plate, so that the separate test systems are maintained in the various test recesses of the first test plate.

As mentioned above, in order to prevent aging effects in the test composition that could adversely affect the result of the method according to the invention, it is advisable to the extent possible to prepare the test composition immediately before bringing the seeds into contact. In this respect, in order to achieve a particularly advantageous effect, the inventors recommend that the fermenting microorganism should be used before mixing with the solvent as a cold-treated microorganism, as also disclosed above. Moreover, in order not to increase the activity of the fermenting microorganism too soon, the inventors recommend that relatively cold water be used in producing the test composition. In an advantageous improvement, this can be done to such an extent that even the temperature of the test composition is kept as low as possible until the moment of contact of the plant seeds in order to prevent an undesirable premature increase in the activity of the fermenting microorganisms. Compared to a method in which the solution is prepared at room temperature, this makes it possible to advantageously prevent any redox processes in the prepared solution from causing initial color changes in the redox indicator, which can distort the results of the subsequent optical measurements. Accordingly, a method according to the invention is preferred wherein the test composition is produced in method step b), wherein the water during production is at a temperature of 8° C. or less, preferably 7° C. or less, preferably 6° C. or less, particularly preferably 5° C. or less. In this respect, a method according to the invention is particularly preferred wherein on bringing the plant seed portions into contact with the plant seed portions, the test composition is at a temperature of 8° C. or less, preferably 7° C. or less, preferably 6° C. or less, particularly preferably 5° C. or less.

By bringing the various plant seed portions into contact with a respective portion of the test composition, a plurality of subunits are obtained, which for the purpose of clear identification are referred to in the context of the present invention as test systems. These test systems thus comprise test composition and a plant seed portion. The person skilled in the art understands that the volume of the respectively added test composition should preferably depend on der size of the plant seeds and/or the number of the plant seeds in the plant seed portion. For individual, small plant seeds, the person skilled in the art will advantageously select a lower volume than for larger plant seed portions of relatively large seeds. The person skilled in the art also understands in this respect that the efficiency of the passage of organic substances from a plant seed into the test composition, which is identified via the combination of the fermenting microorganism and the two-stage redox indicator, usually substantially depends on the contact surface between the plant seeds and the test composition. Although it is thus generally possible to use small test volumes of test composition, which come into contact with only a portion of the plant seeds, according to the inventors' assessment, this is not the preferred method of process control. At the same time, large volumes of test composition also mean that there is a large amount of redox indicator, and it is possible that large portions of the redox indicator will not be able to change color, even in the case of dead seeds. In the inventors' assessment, it is particularly preferable for the test volume of test solution in the test systems to be in the range of 1*Vₛ to 500*Vₛ, preferably in the range of 2*Vₛ to 250*Vₛ, particularly preferably in the range of 3*Vₛ to 125*Vₛ, wherein Vₛ is the combined volume of the plant seeds in the plant seed portion. Additionally or alternatively, a method according to the invention is preferred wherein bringing into contact of the plant seed portions takes place with a respective test volume of test solution in the range of 0.1 to 500,000 μL, preferably in the range of 1 to 50,000 μL, particularly preferably in the range of 10 to 5000 μL.

In order to increase the efficiency of the method according to the invention, the inventors of the present invention recommend that measures be taken to improve wetting of the plant seeds, as this increases the interface and allows more efficient passage of organic substances from the plant seeds into the test composition. In particularly, by means of corresponding measures, the time required to carry out the method according to the invention can be significantly reduced.

As a first, less preferred option for adjusting wetting to an advantageous level, the inventors recommend that the test systems can be centrifuged in order to achieve advantageous wetting. These embodiments therefore concern a method according to the invention wherein bringing of the plant seed portions into contact with a respective test volume of test composition before incubation is supported by a mechanical treatment step, preferably by immersing the plant seeds or centrifuging the test systems, particularly preferably by centrifuging the test systems.

However, the inventors consider the use of a specific surfactant, a so-called detergent, with which in contrast to the method known from the prior art, advantageous wetting of the plant seed portions can be achieved, to be particularly advantageous and preferred for essentially all embodiments of the method according to the invention. This allows the efficiency of the method to be considerably increased, in particular with respect to the time required, without requiring e.g. centrifugation to be carried out. In implementing these preferred embodiments, the inventors consider it essential that rather than any desired surfactant, surfactants should be used that have no negative impact or at least only a minimal negative impact on the bioactivity of the fermenting microorganism. Thus a method according to the invention is particularly preferred wherein the test composition additionally comprises one or more surfactant compounds that are biocompatible with the fermenting microorganism, preferably in a combined mass fraction in the range of 0.001 to 25%, preferably in the range of 0.01 to 5%, particularly preferably in the range of 0.1 to 0.5%, based on the mass of the test solution.

The term biocompatible is clear for the person skilled in the art, and expresses that the activity of a microorganism in the presence of the surfactant compounds is reduced by less than 5%, preferably less than 1%, particularly preferably less than 0.1%, and particularly preferably, essentially not at all. Many suppliers of commercially available detergents indicate in the documentation the extent to which the offered surfactant compounds are tolerable, i.e. biocompatible, for microorganisms, or can provide corresponding data on request. Additionally or alternatively, the person skilled in the art can also determine by means of relatively simple tests on the fermenting microorganism used by him whether an available surfactant compound is sufficiently biocompatible. Specifically, in the inventors' assessment, non-ionic surfactants are most particularly suitable for use in the method according to the invention, wherein in particular polysiloxane-based polymers in experiments conducted by the inventors produced excellent results. Particularly advantageous results were achieved with trisiloxane-based nonionic surfactants in particular. Corresponding anionic surfactants are commercially available from various manufacturers under the brand name Break-Thru, for example as Break-Thru SD260 from Evonic Operations GmbH. Accordingly, a method according to the invention is preferred wherein the surfactant compounds are selected from the group consisting of nonionic surfactants, preferably selected from the group consisting of polysiloxane copolymers, particularly preferably selected from the group consisting of polyether-polyalkylsiloxane-copolymers.

In the method according to the invention, the test systems obtained are then incubated. The step of incubating is clear to the person skilled in the art and refers to the development of the test systems for a predetermined period of time, usually at increased temperature. In the method according to the invention, the incubation time makes it possible in particular to allow the organic substances to escape from plant seeds and to convert these substances by means of the fermenting microorganism. In this respect, the inventors succeeded in identifying particularly advantageous conditions for incubation, by means of which good results can be obtained for most plant seeds of industrially relevant crop plants, wherein the issues of the tradeoff between time and energy efficiency on the one hand and the most reliable possible estimation of the germination properties on the other are solved in these embodiments in a particularly advantageous manner. Accordingly, a method according to the invention is preferred wherein incubation takes for a period in the range of 0.5 to 24 h, preferably in the range of 1 to 12 h, particularly preferably in the range of 1.5 to 8 h. Additionally or alternatively, a method according to the invention is also preferred wherein incubation takes place under exclusion of light. Additionally or alternatively, a method according to the invention is also preferred wherein incubation takes place at a temperature in the range of 6 to 40° C., preferably in the range of 8 to 37° C., particularly preferably in the range of 10 to 35° C. In this context, a method according to the invention is generally preferred wherein incubation takes place for a predetermined period depending on the species of the plant, wherein the predetermined period is preferably specified by plant-seed specific instructions in a kit according to the invention.

The person skilled in the art understands that at the end of incubation in the incubated test systems, a test composition is obtained in which a portion of the two-stage redox indicator changes color once or twice and that these test compositions of the test systems are measured in the further course of the method according to the invention.

This measurement of the test compositions of the incubated test systems takes place in method step d), wherein an optical measurement method is used. Suitable optical measurement methods are known to the person skilled in the art based on his expertise, wherein suitable optical measurement devices, in particular high-performance digital embodiments, are commercially available from various suppliers. For virtually all embodiments, in view of the measurement data to be detected, a method according to the invention is relevant wherein the optical measurement method is an absorption measurement method, preferably a transmission measurement method. Because it is possible to carry out the data processing steps of the method according to the invention on the optical measurement device, a method according to the invention is preferred wherein the optical measuring unit comprises the electronic data processing device.

The person skilled in the art understands that as a result of the change or changes in color in the two-stage redox indicator, the wavelength of the absorption maximum of the test composition shifts, which can be perceived by a person skilled in the art as a change in color, at least for changes in the visible light range. The person skilled in the art also understands that in the method according to the invention, reference is made to a parameter that correlates with the absorption properties of the respective test composition from the incubated test systems.

In this respect, it is clear to the person skilled in the art that the simplest and most direct absorption properties can consist of the directly measured absorption values. At the same time, however, it can be advisable, instead of the directly determined absorption properties, to determine parameters correlating therewith and/or values derived therefrom and/or to determine them in the subsequent evaluation. In particular, the subsequent evaluation can be carried out on standardized or normalized absorption values, which for example are corrected by means of calculation operations in the light of absorption properties determined on blind systems, reference systems and/or control systems, as is also described below. According to the understanding of the person skilled in the art, an absorption data set is accordingly obtained for each test system that comprises data on the absorption properties of the respective test composition, wherein these absorption properties, in addition, the directly determined absorption values, as defined above, can also comprise values derived therefrom.

In contrast to the method known from the prior art, the absorption properties of the respective incubated test compositions are not measured only at 570 nm. Rather, the optical absorption properties of the respective test composition are determined at a first wavelength λ₁ and a second wavelength λ₂, wherein according to the invention, these wavelengths must differ by at least 10 nm. Accordingly, in other words, this is a method according to the invention wherein measurement is carried out with an optical measurement device, preferably an optical photometer, wherein the optical measurement device is configured to determine the optical absorption properties of the test composition for electromagnetic radiation at at least a first wavelength λ₁ and a second wavelength λ₂, wherein λ₁ and λ₂ differ by 10 nm or more.

In light of the above explanations, a method according to the invention is exemplary wherein the absorption properties at least comprise
i) the absorption values of the respective test compositions at the first wavelength λ₁ and the second wavelength λ₂, or
ii) values derived from these absorption values,
wherein the value derived from the absorption values are preferably obtained by means of one or more calculations, in particular by value standardization or value correction, for example, depending on absorption values determined on control systems, reference systems, or blind systems.

The absorption properties of the respective test compositions for electromagnetic radiation at at least a first wavelength λ₁ and a second wavelength λ₂ can for example be determined selectively only at the corresponding wavelengths, for example using essentially monochromatic radiation sources or by using suitable filters. Alternatively, however, spectra over a broad wavelength range can also be taken, and the first and second wavelengths can be read based on the specific wavelengths.

In addition to the specific form of evaluation of the data sets, the advantages of the method according to the invention derive from the fact that absorption data sets determined for the various test systems comprise data on absorption behavior at two different wavelengths that are at a certain minimum distance from each other. The total absorption spectra of the incubated test compositions can be viewed in simplified fashion as superposition, i.e. overlapping, of the mass-fraction-weighted absorption spectra of the components contained therein, in particular the various states of the redox indicators. Based on the minimum distance between the first and second wavelength, the absorption properties of the solution are determined at two wavelengths at a distance from each other, in which the various differing oxidized states of the two-stage redox indicator contribute to different degrees and with deviating ratios to the combined absorption spectrum. This data content of the obtained absorption data sets is considered by the inventors to be essential for downstream evaluation by means of machine learning. In their own experiments, the inventors identified 10 nm as a suitable lower limit with which useful results can still be obtained with acceptable resource requirements, before the changing contributions of the redox states no longer differ sufficiently. However, the inventors recommend that with greater wavelength differences, better estimation results can be achieved in most cases, as the relative contribution of the redox states of the redox indicator in such cases regularly deviates more sharply than in typical absorption spectra. A method according to the invention is therefore preferred wherein the first wavelength λ₁ and the second wavelength λ₂ differ by 15 nm or more, preferably 20 nm or more, particularly preferably 25 nm or more.

Although it would generally be possible to measure absorption behavior at three or more different wavelengths, and additionally for example to determine the absorption properties at a third wavelength λ₃ and a fourth wavelength λ₄, to include the corresponding data in the absorption data sets, and to take this into account in subsequent computer-aided estimation, this is not preferably according to the inventors' assessment. The person skilled in the art understands that although each additionally measured wavelength can potentially increase estimation accuracy, this would entail an increase in equipment expenses in measurement and an increase in the required storage and computing capacity. In the view of the inventors, the outstanding estimation quality that can already be achieved with two wavelengths makes it unnecessary to measure further wavelengths, so the additional effort is not considered to be justified, in particular when the absorption properties are determined at wavelengths that are close to the respective absorption maximum of the relevant redox states of the redox indicator, for example 570 nm and 600 nm for resazurin.

In practice, efficient selection of the first and second wavelengths is essentially determined by selection of the two-stage redox indicator. In this respect, the inventors recommend that provided the above-described minimum distance is maintained, the first wavelength should be in the range of (m₁−20) nm to (m₁+20) nm, preferably in the range of (m₁−10) nm to (m₁+10) nm, wherein mi is the wavelength of the absorption maximum of a redox state of the two-stage redox indicator, and/or the second wavelength should be in the range of (m₂−20) nm to (m₂+20) nm, preferably in the range of (m₂−10) nm to (m₂+10) nm, wherein m₂ is the wavelength of the absorption maximum of a redox state of the two-stage redox indicator.

With respect to the particularly preferably used two-stage redox indicator resazurin, the inventors recommend wave length ranges at which they were able to achieve excellent results in their own experiments and which result in absorption data sets that can be evaluated in the subsequent evaluation in a particularly favorable manner. Specifically, a method according to the invention is preferred wherein the first wavelength λ₁ is in the range of 585 to 630 nm, preferably in the range of 590 to 620 nm, particularly preferably in the range of 595 to 610 nm. Additionally or alternatively, and preferably additionally, a method according to the invention is preferred wherein the second wavelength λ₂ is in the range of 540 to 585 nm, preferably in the range of 550 to 580 nm, particularly preferably in the range of 560 to 575 nm.

In the inventors' assessment, it is at least theoretically possible to subject the test systems directly to transmission measurement, i.e. without previously removing the plant seed portion. In practice, however, as this can result in an inherently avoidable deterioration in the absorption measurement data obtained, the inventors recommend that respective subvolumes of test composition be taken from the incubated test systems and measured by the optical measurement method in order to allow the most efficient process control possible. In this respect, a method according to the invention is preferred wherein the measured test composition of the incubated test systems is separated prior to measurement of the plant seed portions, wherein preferably one subvolume each of the test composition, and particularly preferably a subvolume in the range of 50 to 150 μL, is removed from the test systems in order to be measured, wherein the various subvolumes are preferably transferred into the test of a second transparent test plate.

Before the subsequent evaluation of the absorption data sets obtained for the purpose of estimating the germination properties is explained in further detail below, it is advisable to address aspects that concern in particular method steps a) to d). The person skilled in the art easily understands that a subsequent correlation of the detected absorption properties of the test systems with the germination properties of plant seeds for the purpose of estimating the germination properties is more readily possible and requires less calculation capacity the lower the number of other confounding factors and deviations.

This means for the person skilled in the art that the absorption data sets of the test systems should naturally be produced under the most uniform conditions possible. Such an approach corresponds to the natural approach of the person skilled in the art in designing measurement series. This means for example that preferred similar plant seeds are used, equal-sized plant seed portions are formed, essentially equal volumes of test composition are used, the test composition used in the method has as uniform a composition as possible, the plant seed portion is brought into contact with the test volume in as uniform a manner as possible, and the absorption properties are determined for example under conditions that are as identical as possible, in particular with the same optical measurement devices and measurement method.

Theoretically, a plurality of deviations, in particular if they are relatively minor, can even be compensated for quite well in the downstream evaluation by resorting to machine learning, at least provided that in turn, the available calculation capacity is increased and a correspondingly high-performance estimation module is used. According to the understanding of the person skilled in the art, however, a method according to the invention is advisable for all embodiments in which a plurality of equal-sized plant seed portions of similar plant seeds with essentially the same volumes of an essentially identical test composition are brought into contact and incubated under essentially the same conditions, wherein the test compositions of the test systems incubated in this manner are measured with the same optical measurement method under the same measurement conditions in order to determine the optical absorption properties of the respective test compositions. In this respect, a method according to the invention is particularly preferred wherein each test system contains the same number of plant seeds and essentially the same amount of test composition. A method according to the invention is also particularly preferred wherein the test compositions of the incubated test systems are measured under identical conditions.

According to the inventors' assessment, a further factor that is particularly advantageous with respect to efficient process control is the use of suitable comparison systems that allow efficient evaluation of the plant seed portions measured together.

Initially, in the inventors' assessment, it is particularly advisable to provide so-called blind systems that comprise no plant seed portions or test composition, but exclusively comprise the solvent used in the test composition. These blind systems can be used in particular to correct the optical absorption properties determined in method step d) with respect to any effect of the solvent or sample carrier. A method according to the invention is therefore preferred wherein in method step c), in addition to the plurality of test systems, one or more blind systems is/are produced, incubated with the test system, and measured in method step d), wherein the blind system exclusively comprises the solvent of the test composition, in particular water. A method according to the invention is particularly preferred wherein the optical absorption properties of the respective test compositions determined in method step d) are corrected depending on the optical absorption properties of the one or more blind systems, preferably by subtracting the blind values.

Moreover, the inventors recommend that in addition, control systems can be co-processed in which instead of plant seed portion, a known amount of a fermentable compound is prepared in a controlled manner in order to verify that the text compositions are sufficiently functional, i.e. in order to verify that the fermenting microorganism in particular is active and can cause a color change in a redox indicator. Accordingly, a method according to the invention is preferred wherein in method step c) in addition to the plurality of test systems, one or more control systems is is/are produced, incubated with the test system, and measured in method step d), wherein the control systems comprise a fermentable compound, preferably a carbohydrate compound, in the test composition.

The inventors consider the use of these control systems to be most highly preferred in particular because the absorption properties determined on the respective test compositions of the test systems can be standardized using the absorption properties determined on the control systems. Actually, in practice, the observed biological processes are usually limited in their reproducibility, wherein a variety of environmental factors can impact the activity of the microorganisms and the intensity of leaching. In practice, by using control systems, both biotic fluctuations such as e.g. in the actual concentration of the microorganisms used or the motility thereof, i.e. their fitness, and abiotic fluctuations such as e.g. temperature fluctuations or differing water qualities between measurements on different days and/or at different locations and/or under differing weather conditions can be compensated for, so that comparable data can be obtained under changing conditions. The standardization preferred for essentially all embodiments thus makes it possible to hide these factors at least partially, and in many cases almost completely, which advantageously makes it easier in particular to carry out the method according to the invention outside of highly-controlled laboratory conditions so that implementation of a decentralized method, for example with absorption measurement by the agriculturalist, is significantly easier. In this context, for example, standardization can be carried out for example using the wavelength measurement values, which corresponds to the fully oxidized form of the two-stage redox indicators. In any case, a method according to the invention is particularly preferred wherein the optical absorption properties of the respective test compositions determined in method step d) are standardized on the optical absorption properties of the one or more control systems.

In addition to blind systems and control systems, the inventors recommend that additionally or alternatively, reference systems can also be used that exclusively contain the test composition. These reference systems correspond in their color behavior or absorption to the initial state in which fermentation had not yet caused any color change in the redox indicators. In this manner, the reference systems are particularly well suited for setting suitable incubation conditions. When there is sufficient color contrast between the control system in which fermentation takes place and the reference system, it is often possible to determine with the naked eye alone that incubation has been carried out for a sufficiently long time. A method according to the invention is therefore preferred wherein in method step c), in addition to der plurality of test systems, one or more reference systems are produced, incubated with the test system, and measured in method step d), wherein the reference systems exclusively comprise test composition. Moreover, a method according to the invention is preferred wherein incubation of the test systems is carried out until a predetermined color contrast between the control system and the reference system is observed.

In method step e), estimation of the germination properties of the plant seeds is carried out, which will be disclosed in detail below.

In practice, the isolated data on the estimated germination property of a plant seed or a plant seed portion is usually of little relevance. The added value of the method according to the invention lies in particular in that a larger number of plant seeds, which are representative of larger seed batch, can be analyzed respectively with respect to their germination properties in order to derive therefrom an average germination properties prediction for the seed batch that can be used for the seed batch as a characteristic variable. Initially, a method according to the invention is thus preferred wherein the number of plant seed portions and the number of test systems is 20 or more, preferably 40 or more, particularly preferably 60 or more, most particularly preferably 80 or more. Accordingly, a method according to the invention additionally comprising the following method step is preferred:
f) calculating an average germination properties prediction by averaging from the germination properties estimated for the plant seed portions.

In most cases, it will be advisable to output the data obtained in method step e) in a suitable manner, e.g. via a display, wherein output via an electronic interface for the purpose of further data processing is also conceivable. Accordingly, a method according to the invention is preferred that additionally comprises the following method step:
g) outputting the estimated germination properties or the calculated average germination properties prediction, wherein the outputting is preferably carried out via a data interface or electronic display device of the electronic data processing unit. With a view to simple handling of the output data, outputting in an easily understandable graphical representation is preferred, for example in a so-called box plot, so that direct and intuitive comparison of the available data is made possible in a particularly simple manner.

Evaluation of the absorption data sets assigned to the test systems in order to estimate germination properties is carried out in the method according to the invention with the aid of a computer based on the concept of machine learning (sometimes also referred to as “artificial intelligence” or “AI-based”). In this method, the absorption data sets determined as defined above on the various test systems, which comprise data on the absorption properties of the respective test compositions at the first wavelength λ₁ and the second wavelength λ₂, are entered as input of the electronic data processing device into a machine-learning-based estimation module that carries out the actual estimation and outputs corresponding estimated data on germination properties.

For example, the electronic data processing device can be a separate computer of the end user that is connected for example to the optical measurement device. In the context of an integrated solution, however, it can also be an electronic data processing device that is a component of the optical measurement device. In particularly preferred embodiments, however, the electronic data processing device is a central electronic data processing device, for example a server in cloud-based evaluation that can be connected for example in a network with a plurality of optical measurement devices.

In the context of the present invention, the machine-learning-based module is designated an estimation module for the purpose of proper naming and identification of the module via its function, wherein its capacity to estimate germination properties from the absorption data sets assigned to the test systems results from training of the estimation module. For example, the estimation module can be part of comprehensive software and be present on the storage unit of the electronic data processing device, wherein the term storage unit refers to a storage device that can be accessed by the electronic data processing device and need not necessarily be physically connected to the electronic data processing device, but for example can also be accessible via a wireless communication network.

The concept of machine learning per se and suitable machine learning algorithms are generally well-known to the person skilled in the art based on his expertise. Machine-learning-based modules or computer program products, which can be adapted to the requirements of the present invention by means of the training data sets specified here, are commercially available from numerous manufacturers or developers. In an exemplary method according to the invention, the estimation module is based on a machine learning algorithm that is selected from the group consisting of supervised learning algorithms, preferably selected from the group consisting of supervised learning algorithms for solving regression problems, particularly preferably selected from the group consisting of artificial neuronal networks, and/or wherein the estimation module is obtained by applying a machine learning algorithm to the set of training data, wherein the algorithm is selected from the group consisting of supervised learning algorithms, preferably selected from the group consisting of supervised learning algorithms for solving regression problems, particularly preferably selected from the group consisting of artificial neuronal networks.

The inventors refer in particular to the following publications which are considered to be particularly helpful in this respect:
R Core Team (2021). R: A language and environment for statistical computing. R Foundation for Statistical Computing, Vienna, Austria. URL: https://www.R-project.org/.
Mir3: Lang M, Binder M, Richter J, Schratz P, Pfisterer F, Coors S, Au Q, Casalicchio G, Kotthoff L, Bischl B (2019). “mlr3: A modern object-oriented machine learning framework in R.” Journal of Open Source Software. doi: 10.21105/joss.01903 (URL: https://doi.org/10.21105/joss.01903), URL: https://joss.theoj.org/papers/10.21105/joss.01903.
Mlr3viz: Michel Lang, Patrick Schratz, Raphael Sonabend, Marc Becker and Jakob Richter (2021). mlr3viz: Visualizations for ‘mlr3’. R package version 0.5.7. https://CRAN.R-project.org/package=mlr3viz.
Tidyverse: Wickham et al., (2019). Welcome to the tidyverse. Journal of Open Source Software, 4(43), 1686, https://doi.org/10.21105/joss.01686.

In order to obtain the estimation module (i.e. the training) the person skilled in the art makes use of a training set of training data that comprises corresponding absorption data sets of plant seed portions of plant seeds with known germination properties, wherein these are referred to in the context of the invention as training absorption data sets of training plant seed portions, so that the identification module can be trained by means of so-called supervised learning in order to allow the desired functionality.

Luckily, obtaining a suitable training set is no problem in practice for the person skilled in the art, as carrying out germination tests that are usually oriented to the ISTA specifications is in practice an everyday activity for the person skilled in the art, and the data required for “supervised learning” are also binary in many cases (i.e. germinates/does not germinate). Regardless of the fact that prediction quality can be increased if needed by means of suitable measures, as described below in a practical example, the person skilled in the art thus only has to produce corresponding absorption data sets in the germination tests he would carry out anyway, which in turn can be carried out by method steps a) to d).

In the following, an example is given to illustrate how an exemplary set of training data can be generated. In addition, in table 3 below, an exemplary set of real measured training data are disclosed that give the person skilled in the art an impression of a suitable format of the training data using the example of rapeseed and can also function for test purposes as a first basis for training of an exemplary estimation module.

The inventors recommend that a suitable set of training data for a type of plant seeds can for example be generated as follows:
A. First, the method according to the invention is carried out in the context of a rough screening in order to evaluate the conditions under which conditions an effective differentiation of the absorption properties of the test systems is to be found (variation volume, concentration of RedOx indicator, incubation period, incubation temperature, etc.).
B. When sufficient differentiation has been achieved, large amounts of plant seeds are subjected to method steps a) to d), wherein the incubation takes place under the conditions determined according to point A. In this context, as defined above, blind systems, control systems and reference systems are used in order to obtain background-corrected and normalized data on the absorption properties of the respective test compositions at the first wavelength λ₁ and the second wavelength λ₂.
C. After this, the previously examined plant seeds are seeded according to ISTA criteria in such a manner that assignment of the recorded data sets to the seeded plant seeds remains possible, wherein (depending on the goal of the subsequent training), for example, it can be determined which plant seeds physiologically germinate, the duration until physiological germination, and/or which plant seeds form a “normal seedling.”
D. Despite the non-destructive nature of the method, incubation in the test composition constitutes stress for the plant seeds. In particular, an oxygen deficiency during complete covering with test composition can affect the vitality of the tested plant seeds. This effect of incubation on the germination properties cannot be avoided in compiling the training data. However, the inventors have realized that it is possible, in order to improve estimation quality, the compensate for this effect by subsequently calibrating the data obtained in point C on a non-incubated, i.e. “normal”, seeding according to ISTA. For this purpose, the same number of plant seeds are seeded without prior incubation according to the same ISTA criteria, the same germination properties are recorded, and a calibration function is then determined.

For the training data sets, the inventors usually recommend a size of at least 10 batches of different lots and qualities with at least 400 seeds each, wherein one can at least obtain simpler estimation modules, in many cases even with significantly smaller training data sets.

Using the training data sets obtained, in order to obtain the estimation model in the usual manner by means of machine learning, one can for example train regression models that are trained using the normalized absorption data sets of the at least two wavelengths, the corresponding standardization factor, and the recorded germination properties (e.g. physiologically germinated yes/no). The quality of the models can for example be directly verified using a previously separated proportion of the training data (e.g. approx. 20%) in order in this matter to determine e.g. the mean square error and/or the maximum error of the estimation module obtained and to decide whether further training is optionally required.

From the above explanations, one can derive particularly preferred embodiments of the method according to the invention that can be implemented individually or in a combination of two or more features.

A method according to the invention is preferred wherein the set of training data is 3000 or more, preferably 4000 or more, particularly preferably 5000 or more training absorption data sets of training plant seed portions of plant seeds with known germination properties.

A method according to the invention is generally preferred wherein the set of training data is obtained by carrying out method steps a) to d) of a method according to the invention, preferably a method according to the invention carried out in an essentially identical manner, for a plurality of training plant seed portions in order to obtain training absorption data sets, wherein the germination properties of the plant seeds of the training plant seed portions are determined in subsequent germination properties tests.

A method according to the invention is also preferred wherein the germination properties recorded in the subsequent germination property tests for the plant seeds of the training plant seed portions are corrected by a correction factor that takes into account the reduced germination properties as a result of incubation in the test composition, wherein the correction factor is obtained by correlation with the plant seeds of the same batch in germination properties tests not used in the method.

The person skilled in the art easily understands that the training data set and training upon which the estimation module is based should preferably correlate as extensively as possible with the process control of the method according to the invention. To put it exaggerated, the person skilled in the art does not expect an estimation module that was trained with a training data set produced for plant seeds of type A1, incubation conditions B1 and wavelengths C1 to be meaningfully useable in a method according to the invention that treats plant seeds of type A2 under incubation conditions B2 and determines wavelengths C2 if A1, B1 and C1 are completely different from A2, B2 and C2. Accordingly, a method according to the invention is preferred wherein the set of training data comprises a plurality of training absorption data sets that were obtained by method steps a) to d) of the method according to the invention for the purpose of estimating germination properties, wherein essentially the same process parameters and/or devices were used.

According to the understanding of the person skilled in the art in particular, a method according to the invention is also generally preferred wherein the training absorption data sets of the set of training data:
i) were obtained for plant seeds that correspond to the type of plant seeds provided in the method, and/or
ii) were obtained for training plant seed portions that comprise the same number of plant seeds as the plant seed portions provided in the method, and/or
iii) were obtained for training test systems in which the same test volume of test composition was used as in the test systems obtained in the method, and/or
iv) were obtained for training test systems that were incubated under the same conditions as the test systems incubated in the method, and/or
v) were obtained with the same optical measurement method, preferably using the same optical measurement device as the absorption data sets obtained in the method, and/or
vi) comprise the same data on the absorption properties as the absorption data sets obtained in the method, preferably in the same data structure; wherein particularly preferably 2 or more, preferably 3 or more, particularly preferably 4 or more, most particularly preferably 5 or more, in particular all of these conditions are set.

The invention also relates to a particularly preferred test composition for use in a method according to the invention comprising:
i) water,
ii) a two-stage redox indicator,
iii) a fermenting microorganism, and
iv) a surfactant compound that is biocompatible with the fermenting microorganism, wherein the surfactant compound is selected from the group consisting of nonionic surfactants. According to the inventors' assessment, this test composition is particularly advantageous because it guarantees excellent wetting of the plant seeds with the test composition without having to resort to mechanical methods to increase wetting.

The invention also relates to a kit for producing a test composition according to the invention comprising:
A1) a starting mixture comprising:
ii.b) a two-stage redox indicator,
iii.b) a fermenting microorganism, and
iv.b) a surfactant compound that is biocompatible with the fermenting microorganism, wherein the surfactant compound is selected from the group consisting of nonionic surfactants, or
A2) in separate containers, the subcomponents for producing the starting mixture, and
B) plant-seed-specific production instructions, comprising a production specification for producing a plant-seed-specific test composition by mixing the starting mixture or the subcomponents of the starting mixture with an aqueous solvent, in particular water.

In the inventors' assessment, it is preferable to add to the kit further components that can be useful to the end user in carrying out the method according to the invention.

Specifically, for example, a kit according to the invention is preferred that comprises a test plate with a plurality of test recesses for receiving test systems from plant seed portions and test composition, wherein the test plate preferably comprises 45 or more and preferably 90 or more test recesses.

A kit according to the invention is also preferred comprising a dosing and filling aid for filling a test plate with a plurality of test recesses.

A kit according to the invention is also preferred comprising an optical measurement device, wherein the optical measurement device is configured to determine the optical absorption properties of the test composition for electromagnetic radiation at at least a first wavelength λ₁ and a second wavelength λ₂, wherein λ₁ and λ₂ differ by 10 nm or more.

The invention also relates to a computer program product comprising commands, which on execution of the program by an electronic data processing device cause this device to carry out step e), preferably method steps d) and e), of the method according to the invention, wherein the computer program product comprises the machine-learning-based estimation module and is preferably stored on a portable storage unit, preferably on a USB-readable data carrier.

Moreover, an electronic data processing device for use in a method according to the invention for estimating the germination properties of the plant seeds in the plant seed portions is disclosed, comprising a storage unit and a machine-learning-based estimation module stored on the storage unit, wherein the electronic data processing device is configured to enter as input the absorption data sets obtained in the method according to the invention for the plant seed portions into the estimation module and to estimate the germination properties of the plant seeds in the plant seed portions using the estimation module, wherein the estimation module is trained to estimate the germination properties of the plant seeds in the plant seed portions from the absorption data sets, wherein the training is carried out by means of supervised learning, with a set of training data comprising a plurality of training absorption data sets of training plant seed portions of plant seeds with known germination properties.

In the following, the invention and preferred embodiments of the invention will be explained in greater detail with reference to the attached figures. The figures show the following:

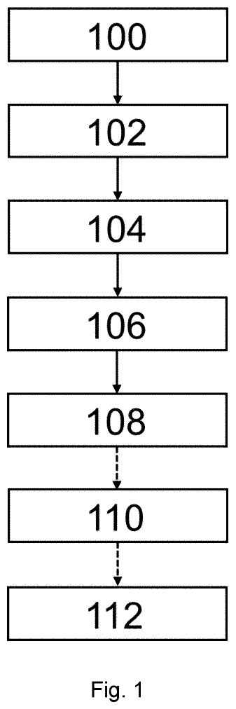

FIG. 1 a schematic flow diagram of a method according to the invention; and

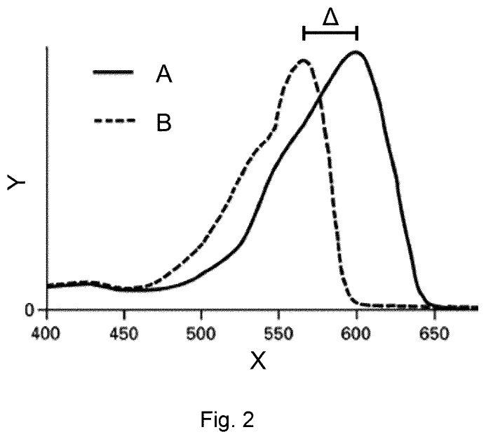

FIG. 2 an absorption spectrum of two RedOx states of the two-stage redox indicator resazurin.

FIG. 1 is a schematic diagram of the method steps of the method according to the invention for the purpose of estimating the germination properties of plant seeds in a preferred embodiment. The estimated germination properties are germination capacity and seed viability according to ISTA criteria.

In method step a) 100 of the exemplary method according to the invention, 80 separate plant seed portions are provided, each consisting of exactly one plant seed of Brassica napus, i.e. a rapeseed. The plant seed portions are individually arranged in test recesses in a so-called multiwell plate.

In method step b) 102, a test composition is produced comprising, based on the mass of the test composition, 99.9705% distilled water, 0.0005% resazurin and 0.004% Saccharomyces cerevisiae, as well as 0.025% of a surfactant compound that is biocompatible with the microorganism, commercially available under the brand name BreakThru SD260 from Evonik Operations GmbH.

The fermenting microorganism is prepared in a freeze-dried state with the resazurin and the surfactant compound as a powder, which is mixed in order to produce the test composition according to plant-seed-specific instructions with cold water (ca. 6° C.). The test composition is produce immediately prior to method step c) 104 so that there is only a slight time lag between production of the test composition and bringing into contact with the plant seed portions. This advantageously makes it possible to largely prevent warming of the test composition in the mean time and the occurrence of aging effects. By means of the surfactant compound used, in method step c) 104 of the method according to the invention, rapid and complete wetting of the plant seeds with the test composition is achieved.

In method step c) 104, each of the plant seed portions is brought into contact with a test volume of 150 μl of test composition in order to obtain 80 separate test systems. The multiwell plate with the test systems is then incubated under exclusion of light for a period of 4 h and at a temperature of about 21° C. Following incubation, 100 μL of test composition is removed from each test system and transferred to a new multiwell plate for subsequent measurement.

In addition to the 80 test systems, in method step c) 104, a total of 4 blind systems exclusively comprising 150 μl of distilled water and a total of 4 control systems comprising 0.3125 mmol of a first carbohydrate compound (i.e. saccharose) in the test composition, 4 control systems comprising 0.078125 mmol of a second carbohydrate compound (i.e. saccharose) in the test composition, and 4 reference systems exclusively comprising 150 μl of test composition are produced and incubated with the test systems on the same multiwell plate.

In method step d) 106, the test compositions of the incubated test systems and the blind, control, and reference systems are finally measured for electromagnetic radiation at a first wavelength λ₁=600 nm and a second wavelength λ₂=570 nm using a photometer of the model absorbance 96 from Byonoy GmbH in a transmission measurement method in order to determine the optical absorption properties (OD values) of the respective test compositions. In this manner, a number of absorption data sets is obtained that corresponds to the number of the test systems. Accordingly, the absorption data sets comprise data on the absorption properties of the respective test compositions at 600 and 570 nm, wherein the values derived from the corresponding absorption values are further processed, said values being corrected taking into account the blind measurements or the control measurements being normalized.

In method step e) 108, the absorption data sets for the purpose of estimating the germination properties of the plant seeds in the respective plant seed portions are subjected to computer-aided analysis. For this purpose, software with an estimation module is used that is based on a machine learning algorithm, which was trained for this purpose by means of supervised learning with a set of training data from training absorption data sets of training plant seed portions of rapeseed having known germination properties, as disclosed above.

In method step f) 110, an average germination properties prediction is then calculated in the form of a box plot by averaging from the germination properties estimated for the plant seed portions. In method step g) 112, this estimated average germination properties prediction is output via an electronic computer.

Table 3 summarizes an exemplary set of training data that were detected by the above-described method steps a) 100 to d) 108 for four sets of 80 plant seeds each. Accordingly, Table 3 comprises for plant seeds (Nos.) the standardized and corrected absorptions at 570 nm (A1) and 600 nm (A2). In addition, for the purpose of supervised learning, the respective relevant result of the seeding test is entered, i.e. whether the plant seeds are physiologically germinated (P) and have formed a normal seedling (N) (1=Yes/0=No).

As an example, for various plant seeds or various seed batches, the inventors compared the estimation accuracy of the method according to the invention (ACC600/570) with that obtained in evaluation on only a single wavelength (ACC570 and ACC600). For this purpose, training is carried out with 80% of the available total data. The remaining 2 0% are presented to the estimation module trained in this manner and compared with the actual germination results (P and N respectively, also referred to as “ground truth”) (prediction>=0.5 is evaluated as 1, prediction<0.5 is evaluated as 0; the proportion of the correct prediction in percent is the accuracy). For Triticum aestivum, for example, the effect of fungicide treatment was also estimated. For this purpose, untreated samples and samples treated with a fungicide (brand name: Vibrance Trio; Syngenta) and a mixture (“partially fungicide-treated,” ratio: 1:1) were taken from the same batch and subjected once each to the method. The respective estimation module was trained on the one hand on the treated or untreated seeds separately and on the other on all the treated/untreated seeds.

The results for germination capacity and seed viability are shown in Tables 1 and 2.

TABLE 1
Accuracy values in estimating germination capacity

| Model | Acc600/570 | Acc600 | Acc570 |
|---|---|---|---|
| Beta vulgaris | 0.779 | 0.723 | 0.718 |
| Hordeum vulgare | 0.767 | 0.689 | 0.697 |
| Triticum aestivum | 0.827 | 0.743 | 0.739 |
| (partially fungicide-treated) | | | |
| Triticum aestivum | 0.800 | 0.778 | 0.778 |
| (fungicide-treated) | | | |
| Triticum aestivum | 0.820 | 0.685 | 0.693 |
| (partially fungicide-treated) | | | |
| Brassica napus | 0.874 | 0.865 | 0.863 |
| Brassica napus | 0.875 | 0.831 | 0.828 |
| Triticum aestivum (untreated) | 0.810 | 0.688 | 0.730 |
| Brassica oleracea | 0.902 | 0.867 | 0.891 |
| Triticum aestivum (untreated) | 0.885 | 0.661 | 0.730 |
| Triticum aestivum | 0.878 | 0.722 | 0.662 |
| (fungicide-treated) | | | |
| Brassica oleracea | 0.896 | 0.857 | 0.836 |
| Beta vulgaris | 0.909 | 0.630 | 0.635 |

TABLE 2
Accuracy values in estimating seed viability

| Modell | Acc600/570 | Acc600 | Acc570 |
|---|---|---|---|
| Beta vulgaris | 0.688 | 0.524 | 0.576 |
| Hordeum vulgare | 0.781 | 0.714 | 0.759 |
| Triticum aestivum | 0.788 | 0.719 | 0.730 |
| (partially fungicide-treated) | | | |
| Triticum aestivum | 0.800 | 0.769 | 0.784 |
| (fungicide-treated) | | | |
| Tritcum aestivum | 0.812 | 0.695 | 0.699 |
| (partially fungicide-treated) | | | |
| Brassica napus | 0.827 | 0.810 | 0.804 |
| Brassica napus | 0.827 | 0.794 | 0.812 |
| Triticum aestivum | 0.835 | 0.668 | 0.747 |
| (untreated) | | | |
| Brassica oleracea | 0.864 | 0.823 | 0.853 |
| Triticum aestivum | 0.878 | 0.661 | 0.714 |
| (untreated) | | | |
| Triticum aestivum | 0.887 | 0.709 | 0.691 |
| (fungicide-treated) | | | |
| Brassica oleracea | 0.891 | 0.836 | 0.841 |
| Beta vulgaris | 0.932 | 0.659 | 0.788 |

The estimation according to the method according to the invention consistently shows improved estimation quality and provides the best estimation in all cases. It should be borne in mind that the comparison values ACC600 and ACC570 were evaluated compared to the method known from the prior art, also using a machine-learning-based estimation module, so that the comparison values shown here, compared to the relatively simple regression method known from the prior art, already show significantly improved estimation quality.

In FIG. 2, in order to illustrate the effect of a color change in the redox indicator, absorption spectra of the two-stage redox indicator resazurin are graphically illustrated in various RedOx states A and B, wherein the Y axis shows the absorption and the X axis the wavelength in nanometers. Absorption spectrum A was measured on resazurin and shows an absorption maximum at 600 nm. The absorption spectrum B was measured on resorufin, i.e. on reduced resazurin, and shows an absorption maximum at 570 nm. Accordingly, the reduction of resazurin to resorufin causes a shift in the absorption maximum of about Δ=30 nm. Determination of absorption properties for the two absorption maxima is particularly efficient in the method according to the invention particularly efficient, because as can be seen from FIG. 2, particularly pronounced differences between the absorption of the two components can be seen at these wavelengths.

TABLE 3
Exemplary training data set

| No. | A1 | A2 | P | N |
|---|---|---|---|---|
| 1 | 5.76 | 7.14 | 1 | 1 |
| 2 | 6.36 | 8.08 | 1 | 1 |
| 3 | 3.64 | 4.06 | 0 | 0 |
| 4 | 6.03 | 7.66 | 1 | 1 |
| 5 | 6.25 | 7.78 | 1 | 1 |
| 6 | 5.18 | 6.38 | 1 | 1 |
| 7 | 1.85 | 1.82 | 0 | 0 |
| 8 | 4.69 | 5.79 | 1 | 1 |
| 9 | 3.38 | 3.67 | 1 | 1 |
| 10 | 5.02 | 6.28 | 1 | 0 |
| 11 | 6.24 | 7.91 | 1 | 1 |
| 12 | 5.02 | 5.92 | 0 | 0 |
| 13 | 4.92 | 6.08 | 1 | 1 |
| 14 | 4.48 | 5.56 | 1 | 1 |
| 15 | 3.09 | 3.16 | 0 | 1 |
| 16 | 5.49 | 6.86 | 1 | 1 |
| 17 | 5.33 | 6.42 | 1 | 1 |
| 18 | 5.88 | 7.47 | 1 | 1 |
| 19 | 3.60 | 4.21 | 0 | 0 |
| 20 | 6.09 | 7.73 | 1 | 1 |
| 21 | 4.48 | 5.46 | 1 | 1 |
| 22 | 3.66 | 4.51 | 1 | 1 |
| 23 | 5.16 | 6.29 | 1 | 1 |
| 24 | 4.69 | 6.00 | 1 | 1 |
| 25 | 4.17 | 4.91 | 1 | 1 |
| 26 | 6.39 | 8.10 | 1 | 1 |
| 27 | 2.87 | 3.32 | 1 | 1 |
| 28 | 3.52 | 4.11 | 1 | 1 |
| 29 | 4.23 | 4.94 | 1 | 1 |
| 30 | 5.27 | 6.41 | 1 | 1 |
| 31 | 5.21 | 6.52 | 1 | 0 |
| 32 | 5.01 | 6.13 | 1 | 1 |
| 33 | 4.89 | 6.16 | 1 | 1 |
| 34 | 5.68 | 6.58 | 1 | 1 |
| 35 | 3.72 | 4.33 | 1 | 1 |
| 36 | 5.24 | 6.59 | 0 | 0 |
| 37 | 5.21 | 6.56 | 1 | 1 |
| 38 | 5.57 | 7.06 | 1 | 1 |
| 39 | 3.74 | 4.44 | 0 | 0 |
| 40 | 5.04 | 6.09 | 1 | 0 |
| 41 | 3.87 | 4.50 | 0 | 0 |
| 42 | 6.12 | 7.76 | 1 | 1 |
| 43 | 4.82 | 6.17 | 1 | 1 |
| 44 | 3.08 | 3.39 | 0 | 0 |
| 45 | 5.59 | 6.82 | 1 | 0 |
| 46 | 5.51 | 6.64 | 1 | 1 |
| 47 | 5.90 | 7.39 | 1 | 1 |
| 48 | 4.00 | 4.70 | 1 | 1 |
| 49 | 6.37 | 8.16 | 1 | 1 |
| 50 | 6.41 | 8.07 | 1 | 1 |
| 51 | 4.83 | 6.02 | 1 | 1 |
| 52 | 5.19 | 6.46 | 1 | 1 |
| 53 | 4.71 | 5.77 | 1 | 1 |
| 54 | 4.96 | 6.20 | 1 | 1 |
| 55 | 4.86 | 6.14 | 1 | 1 |
| 56 | 5.49 | 6.68 | 1 | 1 |
| 57 | 5.71 | 7.08 | 0 | 0 |
| 58 | 3.69 | 4.05 | 1 | 1 |
| 59 | 3.55 | 4.26 | 1 | 1 |
| 60 | 3.04 | 3.38 | 1 | 1 |
| 61 | 5.17 | 6.41 | 1 | 1 |
| 62 | 4.74 | 5.92 | 1 | 1 |
| 63 | 5.37 | 6.66 | 1 | 1 |
| 64 | 4.97 | 6.00 | 1 | 0 |
| 65 | 4.07 | 4.90 | 1 | 1 |
| 66 | 3.65 | 4.40 | 1 | 1 |
| 67 | 5.54 | 7.04 | 1 | 1 |
| 68 | 5.60 | 7.00 | 1 | 1 |
| 69 | 5.70 | 6.91 | 1 | 1 |
| 70 | 4.68 | 5.69 | 1 | 0 |
| 71 | 4.73 | 5.90 | 1 | 1 |
| 72 | 6.09 | 7.72 | 1 | 1 |
| 73 | 4.80 | 5.81 | 1 | 1 |
| 74 | 2.91 | 3.39 | 0 | 0 |
| 75 | 4.85 | 5.82 | 1 | 1 |
| 76 | 6.17 | 7.76 | 1 | 1 |
| 77 | 5.42 | 6.57 | 1 | 1 |
| 78 | 3.75 | 4.40 | 1 | 1 |
| 79 | 3.15 | 3.51 | 1 | 1 |
| 80 | 5.30 | 6.53 | 1 | 1 |
| 81 | 6.53 | 8.11 | 1 | 1 |
| 82 | 6.58 | 8.22 | 1 | 1 |
| 83 | 4.50 | 5.56 | 1 | 1 |
| 84 | 5.76 | 7.36 | 1 | 1 |
| 85 | 6.27 | 7.86 | 1 | 1 |
| 86 | 6.35 | 7.96 | 1 | 0 |
| 87 | 4.39 | 5.52 | 1 | 1 |
| 88 | 4.02 | 4.83 | 1 | 1 |
| 89 | 5.31 | 6.27 | 0 | 0 |
| 90 | 4.14 | 4.86 | 1 | 0 |
| 91 | 4.64 | 5.65 | 1 | 1 |
| 92 | 6.88 | 8.48 | 1 | 1 |
| 93 | 4.58 | 5.61 | 1 | 1 |
| 94 | 3.77 | 4.51 | 1 | 1 |
| 95 | 5.84 | 7.42 | 1 | 1 |
| 96 | 4.94 | 6.15 | 1 | 1 |
| 97 | 4.13 | 4.77 | 1 | 1 |
| 98 | 3.75 | 4.39 | 1 | 1 |
| 99 | 4.32 | 5.07 | 1 | 1 |
| 100 | 5.79 | 7.26 | 1 | 1 |
| 101 | 3.90 | 4.61 | 1 | 1 |
| 102 | 3.79 | 4.57 | 1 | 1 |
| 103 | 4.85 | 5.93 | 1 | 1 |
| 104 | 3.73 | 4.45 | 1 | 1 |
| 105 | 5.26 | 6.65 | 1 | 1 |
| 106 | 4.71 | 5.17 | 1 | 1 |
| 107 | 4.86 | 6.16 | 1 | 1 |
| 108 | 4.97 | 6.08 | 1 | 1 |
| 109 | 4.44 | 5.24 | 1 | 1 |
| 110 | 4.98 | 6.02 | 1 | 1 |
| 111 | 4.20 | 5.08 | 1 | 1 |
| 112 | 4.96 | 5.96 | 1 | 1 |
| 113 | 4.81 | 5.75 | 1 | 1 |
| 114 | 4.97 | 6.22 | 1 | 1 |
| 115 | 4.66 | 5.54 | 1 | 1 |
| 116 | 5.97 | 7.26 | 1 | 1 |
| 117 | 5.42 | 6.65 | 1 | 1 |
| 118 | 3.48 | 3.88 | 0 | 0 |
| 119 | 5.48 | 6.65 | 1 | 1 |
| 120 | 4.70 | 5.68 | 1 | 1 |
| 121 | 5.08 | 6.12 | 1 | 1 |
| 122 | 5.72 | 7.18 | 1 | 1 |
| 123 | 5.31 | 6.61 | 1 | 1 |
| 124 | 4.28 | 5.22 | 1 | 1 |
| 125 | 5.46 | 6.87 | 1 | 1 |
| 126 | 6.31 | 7.90 | 1 | 1 |
| 127 | 5.97 | 7.46 | 1 | 1 |
| 128 | 3.68 | 4.03 | 1 | 1 |
| 129 | 5.51 | 6.81 | 1 | 1 |
| 130 | 1.61 | 1.67 | 0 | 0 |
| 131 | 6.23 | 7.72 | 1 | 1 |
| 132 | 5.53 | 7.04 | 1 | 1 |
| 133 | 2.65 | 2.82 | 0 | 0 |
| 134 | 5.06 | 6.34 | 1 | 1 |
| 135 | 4.35 | 5.24 | 1 | 1 |
| 136 | 5.35 | 6.65 | 1 | 1 |
| 137 | 4.16 | 4.89 | 1 | 1 |
| 138 | 5.24 | 6.67 | 1 | 1 |
| 139 | 5.85 | 7.38 | 1 | 1 |
| 140 | 5.76 | 7.04 | 1 | 0 |
| 141 | 3.23 | 3.15 | 1 | 1 |
| 142 | 5.85 | 7.25 | 1 | 1 |
| 143 | 4.51 | 5.55 | 0 | 0 |
| 144 | 3.85 | 4.57 | 1 | 1 |
| 145 | 4.66 | 5.70 | 1 | 1 |
| 146 | 2.52 | 2.62 | 0 | 0 |
| 147 | 5.44 | 6.60 | 1 | 1 |
| 148 | 5.54 | 7.10 | 1 | 1 |
| 149 | 5.13 | 6.31 | 1 | 1 |
| 150 | 3.14 | 3.64 | 1 | 1 |
| 151 | 5.69 | 7.08 | 0 | 0 |
| 152 | 5.66 | 7.00 | 1 | 1 |
| 153 | 5.44 | 6.68 | 1 | 1 |
| 154 | 2.86 | 3.29 | 1 | 1 |
| 155 | 4.59 | 5.39 | 0 | 0 |
| 156 | 4.59 | 5.51 | 1 | 1 |
| 157 | 6.17 | 7.81 | 1 | 1 |
| 158 | 3.56 | 4.23 | 0 | 0 |
| 159 | 4.34 | 5.31 | 1 | 1 |
| 160 | 5.81 | 7.35 | 1 | 1 |
| 161 | 5.41 | 6.91 | 1 | 1 |
| 162 | 5.81 | 7.27 | 1 | 1 |
| 163 | 3.13 | 3.66 | 1 | 1 |
| 164 | 6.05 | 7.41 | 1 | 1 |
| 165 | 6.27 | 7.86 | 1 | 1 |
| 166 | 4.59 | 5.65 | 1 | 1 |
| 167 | 4.02 | 4.79 | 1 | 1 |
| 168 | 4.64 | 5.75 | 1 | 1 |
| 169 | 4.82 | 5.87 | 1 | 1 |
| 170 | 5.13 | 6.37 | 1 | 1 |
| 171 | 5.78 | 6.88 | 1 | 1 |
| 172 | 3.52 | 4.06 | 1 | 1 |
| 173 | 5.78 | 7.25 | 1 | 1 |
| 174 | 5.19 | 6.27 | 1 | 1 |
| 175 | 4.23 | 5.14 | 1 | 1 |
| 176 | 4.55 | 5.22 | 1 | 1 |
| 177 | 5.88 | 7.46 | 1 | 1 |
| 178 | 6.00 | 7.43 | 1 | 1 |
| 179 | 6.00 | 7.58 | 1 | 1 |
| 180 | 4.65 | 5.75 | 1 | 1 |
| 181 | 5.36 | 6.53 | 1 | 1 |
| 182 | 3.96 | 4.44 | 1 | 1 |
| 183 | 5.60 | 7.07 | 1 | 1 |
| 184 | 5.56 | 7.05 | 1 | 1 |
| 185 | 3.81 | 4.49 | 1 | 1 |
| 186 | 6.08 | 7.39 | 1 | 1 |
| 187 | 4.71 | 5.75 | 1 | 1 |
| 188 | 4.08 | 5.13 | 1 | 1 |
| 189 | 4.16 | 4.65 | 0 | 0 |
| 190 | 5.20 | 6.57 | 1 | 1 |
| 191 | 4.64 | 5.63 | 1 | 1 |
| 192 | 4.05 | 4.86 | 1 | 1 |
| 193 | 3.56 | 4.22 | 0 | 0 |
| 194 | 4.92 | 6.14 | 1 | 1 |
| 195 | 4.76 | 5.90 | 1 | 1 |
| 196 | 5.62 | 7.08 | 1 | 1 |
| 197 | 6.68 | 8.42 | 1 | 1 |
| 198 | 6.23 | 7.83 | 1 | 1 |
| 199 | 5.42 | 6.64 | 1 | 1 |
| 200 | 6.31 | 7.81 | 1 | 1 |
| 201 | 5.61 | 6.84 | 1 | 1 |
| 202 | 5.28 | 6.43 | 1 | 1 |
| 203 | 4.22 | 5.25 | 0 | 0 |
| 204 | 2.06 | 1.98 | 0 | 0 |
| 205 | 4.69 | 5.72 | 1 | 1 |
| 206 | 5.85 | 7.39 | 1 | 1 |
| 207 | 3.14 | 3.27 | 0 | 0 |
| 208 | 4.25 | 5.17 | 1 | 1 |
| 209 | 4.78 | 5.88 | 1 | 1 |
| 210 | 4.01 | 4.82 | 1 | 1 |
| 211 | 4.01 | 4.54 | 0 | 0 |
| 212 | 6.67 | 8.08 | 1 | 1 |
| 213 | 5.93 | 7.43 | 1 | 1 |
| 214 | 4.66 | 5.66 | 1 | 1 |
| 215 | 4.87 | 5.82 | 1 | 1 |
| 216 | 4.73 | 5.82 | 1 | 1 |
| 217 | 5.03 | 5.96 | 0 | 0 |
| 218 | 4.26 | 5.27 | 1 | 1 |
| 219 | 4.08 | 4.90 | 1 | 1 |
| 220 | 5.36 | 6.70 | 1 | 1 |
| 221 | 5.42 | 6.65 | 1 | 1 |
| 222 | 3.13 | 3.48 | 1 | 1 |
| 223 | 5.04 | 6.33 | 1 | 1 |
| 224 | 5.17 | 6.34 | 1 | 1 |
| 225 | 4.38 | 5.29 | 1 | 0 |
| 226 | 4.43 | 5.61 | 1 | 1 |
| 227 | 3.49 | 4.08 | 1 | 1 |
| 228 | 3.23 | 3.75 | 1 | 0 |
| 229 | 4.69 | 5.78 | 1 | 1 |
| 230 | 4.07 | 4.97 | 1 | 1 |
| 231 | 4.17 | 5.04 | 1 | 1 |
| 232 | 5.26 | 6.49 | 0 | 0 |
| 233 | 4.11 | 4.86 | 1 | 1 |
| 234 | 3.35 | 3.53 | 1 | 1 |
| 235 | 5.20 | 6.61 | 1 | 1 |
| 236 | 5.56 | 7.06 | 1 | 1 |
| 237 | 5.11 | 6.42 | 1 | 1 |
| 238 | 4.20 | 5.12 | 1 | 1 |
| 239 | 5.24 | 6.59 | 1 | 0 |
| 240 | 5.77 | 7.39 | 1 | 1 |
| 241 | 4.50 | 5.24 | 1 | 1 |
| 242 | 6.44 | 8.08 | 1 | 1 |
| 243 | 4.48 | 5.50 | 1 | 1 |
| 244 | 4.61 | 5.68 | 1 | 1 |
| 245 | 3.82 | 4.50 | 1 | 1 |
| 246 | 4.78 | 5.84 | 1 | 0 |
| 247 | 7.07 | 7.06 | 1 | 1 |
| 248 | 4.65 | 5.84 | 1 | 1 |
| 249 | 5.82 | 5.81 | 1 | 1 |
| 250 | 5.97 | 5.96 | 1 | 1 |
| 251 | 6.30 | 7.75 | 1 | 1 |
| 252 | 4.44 | 5.39 | 0 | 0 |
| 253 | 4.37 | 5.31 | 1 | 1 |
| 254 | 3.76 | 4.25 | 1 | 1 |
| 255 | 5.18 | 6.28 | 1 | 1 |
| 256 | 5.70 | 5.69 | 1 | 1 |
| 257 | 4.61 | 5.65 | 1 | 1 |
| 258 | 2.87 | 3.31 | 1 | 0 |
| 259 | 4.40 | 5.44 | 0 | 0 |
| 260 | 5.86 | 7.48 | 1 | 1 |
| 261 | 5.00 | 6.04 | 1 | 1 |
| 262 | 5.74 | 7.30 | 1 | 1 |
| 263 | 6.12 | 7.62 | 1 | 1 |
| 264 | 5.88 | 7.06 | 1 | 1 |
| 265 | 4.13 | 5.11 | 1 | 1 |
| 266 | 4.38 | 5.41 | 1 | 1 |
| 267 | 4.17 | 5.01 | 1 | 1 |
| 268 | 4.34 | 5.39 | 1 | 1 |
| 269 | 5.41 | 6.55 | 1 | 1 |
| 270 | 4.43 | 5.19 | 1 | 0 |
| 271 | 4.70 | 5.77 | 1 | 1 |
| 272 | 4.58 | 5.50 | 1 | 0 |
| 273 | 6.48 | 8.12 | 1 | 1 |
| 274 | 5.07 | 6.28 | 1 | 0 |
| 275 | 4.91 | 5.99 | 1 | 1 |
| 276 | 4.76 | 5.64 | 0 | 0 |
| 277 | 4.82 | 5.83 | 1 | 1 |
| 278 | 4.94 | 6.17 | 1 | 1 |
| 279 | 2.67 | 2.97 | 1 | 0 |
| 280 | 5.96 | 7.46 | 1 | 1 |
| 281 | 5.35 | 6.51 | 1 | 1 |
| 282 | 5.76 | 7.04 | 0 | 0 |
| 283 | 4.49 | 5.61 | 1 | 1 |
| 284 | 3.71 | 4.12 | 1 | 0 |
| 285 | 4.88 | 5.86 | 1 | 1 |
| 286 | 5.38 | 6.46 | 1 | 1 |
| 287 | 4.30 | 5.00 | 1 | 1 |
| 288 | 6.31 | 7.89 | 1 | 1 |
| 289 | 5.67 | 6.90 | 1 | 1 |
| 290 | 4.50 | 5.26 | 1 | 1 |
| 291 | 4.88 | 6.04 | 1 | 1 |
| 292 | 4.27 | 5.20 | 1 | 1 |
| 293 | 4.99 | 6.26 | 1 | 1 |
| 294 | 4.69 | 5.53 | 1 | 1 |
| 295 | 5.71 | 7.01 | 0 | 0 |
| 296 | 4.91 | 6.00 | 1 | 1 |
| 297 | 6.49 | 8.14 | 1 | 1 |
| 298 | 4.47 | 5.35 | 1 | 1 |
| 299 | 3.95 | 4.79 | 1 | 1 |
| 300 | 4.65 | 5.61 | 1 | 1 |
| 301 | 4.65 | 5.67 | 1 | 1 |
| 302 | 6.01 | 7.58 | 1 | 1 |
| 303 | 5.66 | 7.10 | 1 | 1 |
| 304 | 3.75 | 4.47 | 1 | 1 |
| 305 | 4.32 | 5.00 | 1 | 0 |
| 306 | 4.33 | 5.22 | 1 | 1 |
| 307 | 5.63 | 7.02 | 1 | 1 |
| 308 | 3.47 | 4.10 | 1 | 1 |
| 309 | 5.22 | 6.31 | 1 | 1 |
| 310 | 6.06 | 7.63 | 1 | 0 |
| 311 | 6.26 | 7.96 | 1 | 1 |
| 312 | 3.81 | 4.40 | 1 | 1 |
| 313 | 4.36 | 5.20 | 1 | 1 |
| 314 | 4.06 | 4.70 | 1 | 0 |
| 315 | 6.07 | 7.28 | 1 | 1 |
| 316 | 4.14 | 5.05 | 1 | 1 |
| 317 | 4.92 | 5.98 | 1 | 1 |
| 318 | 5.01 | 6.30 | 1 | 1 |
| 319 | 4.69 | 5.82 | 1 | 1 |
| 320 | 5.62 | 7.16 | 1 | 1 |

### LIST OF REFERENCE NOS

100 Method step a)
102 Method step b)
104 Method step c)
106 Method step d)
108 Method step e)
110 Method step f)
112 Method step g)

1. A method for estimating the germination properties of plant seeds, comprising the following method steps:
a) Providing a plurality of separate plant seed portions, each comprising at least one plant seed,
b) producing or providing a test composition comprising:
i) water,
ii) a two-stage redox indicator, and
iii) a fermenting microorganism,
c) bringing the plant seed portions into contact with a respective test volume of test composition in order to obtain a plurality of separate test systems, and incubating the test systems,
d) measuring the test compositions of the incubated test systems using an optical measurement method in order to determine the optical absorption properties of the respective test compositions for electromagnetic radiation at at least a first wavelength λ₁ and a second wavelength λ₂ in order to obtain a plurality of absorption data records assigned to the respective test systems,
wherein the absorption data sets comprise data on the absorption properties of the respective test compositions at the first wavelength λ₁ and the second wavelength λ₂,
wherein λ₁ and λ₂ differ by 10 nm or more,
e) evaluating the absorption data sets assigned to the test systems for the purpose of estimating the germination properties of the plant seeds in the respective plant seed portions using an electronic data processing device, wherein the electronic data processing device comprises a storage unit,
wherein a machine-learning-based estimation module is stored on the storage unit,
wherein the electronic data processing device is configured to enter the absorption data sets obtained for the plant seed portions into the estimation module as input and to estimate the germination properties of the plant seeds in the plant seed portions using the estimation module,
wherein the estimation module is trained to estimate the germination properties of the plant seeds in the plant seed portions from the absorption data sets, wherein the training is carried out by means of supervised learning with a set of training data comprising a plurality of training absorption data sets of training plant seed portions of plant seeds with known germination properties.

2. The method according to claim 1, wherein the two-stage redox indicator is resazurin.

3. The method according to one of claim 1 or 2, wherein the fermenting microorganism is selected from the group consisting of unicellular fungi.

4. The method according to one of claims 1 to 3, wherein the test composition additionally comprises one or more surfactant compounds that are biocompatible with the fermenting microorganism.

5. The method according to one of claims 1 to 4, wherein the surfactant compounds are selected from the group consisting of surfactants that are acceptable for the fermenting microorganism.

6. The method according to one of claims 1 to 5, wherein the first wavelength λ₁ and the second wavelength λ₂ differ by 15 nm or more.

7. The method according to one of claims 1 to 6, wherein the first wavelength λ₁ is in the range of 585 to 630 nm, and/or wherein the second wavelength λ₂ is in the range of 540 to 585 nm.

8. A test composition for use in a method according to one of claims 1 to 7 comprising:
i) water,
ii) a two-stage redox indicator,
iii) a fermenting microorganism, and
iv) a surfactant compound that is biocompatible with the fermenting microorganism, wherein the surfactant compound is selected from the group consisting of nonionic surfactants.

9. A kit for producing a test composition according to claim 8 comprising:
A1) a starting mixture comprising:
ii.b) a two-stage redox indicator,
iii.b) a fermenting microorganism, and
iv.b) a surfactant compound that is biocompatible with the fermenting microorganism, wherein the surfactant compound is selected from the group consisting of nonionic surfactants,
or
A2) in separate containers, the subcomponents for producing the starting mixture, and
B) plant-seed-specific production instructions, comprising a production specification for producing a plant-seed-specific test composition by mixing the starting mixture with an aqueous solvent.

10. A computer program product, comprising commands, which on execution of the program by an electronic data processing device cause this device to carry out method step e), preferably method steps d) and e), of the method according to one of claims 1 to 8, wherein the computer program product comprises the machine-learning-based estimation module.
